(19) United States
(12) Patent Application Publication
(10) Pub. No.: US 2013/0275481 A1
(43) Pub. Date: Oct. 17, 2013

(54) Method for the Low Cost Operation of a Processing Machine

(71) Applicant: Robert Bosch GmbH, Stuttgart (DE)

(72) Inventors: Stephan Schultze, Lohr-Wombach (DE); Alexander Koehl, Lohr-Pflochsbach (DE)

(21) Appl. No.: 13/645,852

(22) Filed: Oct. 5, 2012

(30) Foreign Application Priority Data
Oct. 8, 2011 (DE) 10 2011 115 432.2

(51) Int. Cl. G06F 7/544

(52) U.S. Cl. CPC G06F 7/544
USPC 708/200

(57) ABSTRACT

A method for low cost operation of a processing machine comprising determining a suitable processing speed, operating the processing machine at the suitable processing speed, and determining costs as a function of the processing speed. The suitable processing speed is the processing speed which leads to predetermined costs in a predetermined processing time during the operation of the processing machine.

This application claims priority under 35 U.S.C. §119 to patent application no. DE 10 2011 115 432.2, filed on Oct. 8, 2011 in Germany, the disclosure of which is incorporated herein by reference in its entirety.

### BACKGROUND

The present disclosure relates to a method for the low cost operation of a processing machine and to an arithmetic logic unit for carrying out the method.

The disclosure relates to the low cost operation of processing machines which are operated at a specific processing speed, that is to say which execute a specific number of processing steps in a prescribed time interval, and/or produce a specific number of products in the prescribed time interval. In general terms, such processing machines are industrial machines, for example printing machines, packaging machines, CNC machines, conveyor belts and many more.

If, for example, the energy consumption is considered as costs, the costs derived essentially from the energy consumption for the processing (“processing costs”) and the energy consumption for any downtimes (“outage costs”). The range then reaches from a maximally permissible processing speed and maximum downtime to a minimum permissible processing speed (in order to be able to execute the desired number of processing steps/products even in the prescribed time) without downtime. In the prior art, the machine operator has no checkpoints of any sort for prescribing the low cost processing speed. Relevant industrial machines are therefore usually operated at the maximum permissible processing speed. DE 10 2007 062 287 A1 discloses the possibility of energy saving with printing machines, for example by reducing the processing speed. However, a lowest cost processing speed is not itself disclosed.

It is therefore desirable to specify a possibility as to how a processing machine can be operated with the least possible costs in as simple a way as possible.

### SUMMARY

The disclosure proposes a method for the low cost operation of a processing machine and an arithmetic logic unit for carrying out the method having the features described below. Advantageous refinements are the subject matter of the following description.

The disclosure specifies a possibility as to how a processing machine can be operated as far as possible at low cost. To this end, the costs are determined as a function of the processing speed, and a processing speed that leads to desired costs (usually as low as possible) is then prescribed (preferably automatically). What is considered as costs are energy consumption, but also financial costs that, if appropriate, in addition to the energy costs also take account of labor costs (salary costs), maintenance charges (for example increased wear during an increased processing speed) and/or other financial costs. At least some of the method steps, in particular calculations, are run in an arithmetic logic unit. Fundamental relationships between processing speed and costs are explained further below with reference to FIG. 2.

The method is suitable, in particular, for machines having a low base load and a power consumption that rises superproportionately given an increasing rate of production, since the cost saving is greatest here. Machines having electric drives whose power consumption for acceleration and deceleration rises with the rate of production, or machines having motors, blowers or pumps, whose speed rises with the rate of production are particularly suitable for the method.

It is preferred that account need be taken only of processing speeds between the above-named minimum permissible processing speed and maximum permissible processing speed limits, and this simplifies the determination of the suitable processing speed.

In a preferred embodiment, determined suitable processing speeds are stored in product-specific fashion, for example in a computerized database. The storage can preferably also be performed as a function of environmental parameters such as, for example, temperature, air humidity and the like, which likewise influence the energy consumption according to experience. If processing is performed again at a later time under the same boundary conditions, it is advantageously possible to have recourse to the stored data.

It is expedient to form a relationship between the processing speed v and the available processing time T_{ges}. The number of processing steps and/or products needed to be completed within the processing time T_{ges} is denoted by N. For example, the processing costs usually depend on time and processing speed, while outage costs (for example off or standby) usually depend only on time. The required processing time T_{prod} is yielded as the quotient N/v.

In a preferred embodiment, a cost function is determined for the dependence of the costs on the processing speed, preferably as a polynomial function, preferably of 3^{rd} degree, and the suitable processing speed is determined therefrom. Alternatively, the suitable processing speed can be measured by determining or measuring the costs, and running the processing speed through over the permissible range. The processing speed for which the desired (for example lowest) costs are measured (that is to say the suitable processing speed) is then used for the operation.

A polynomial function of 3^{rd} degree is particularly suitable for a sufficiently accurate approximation of the cost function in conjunction with acceptable computational complexity. The degrees of the polynomial function can be assigned to various subprocesses in accordance with the following table.

| | Power demand given | |
|---|---|---|
| Degree | increasing speed | Example |
| 0 | Constant | Power consumption of the control, |
| | | heating or cooling, control parts of the |
| | | drives, infrastructure |
| 1 | Rising linearly | Kinetic friction, product-dependent |
| | | energy (heating power per product, |
| | | converting energy per product, . . . ) |
| 2 | Rising quadratically | I²R of an electric motor being driven, |
| | | winding losses owing to higher |
| | | accelerations → motor current I is |
| | | proportional to the acceleration, |
| | | conversion of the kinetic energy into |
| | | heat owing to bleeder resistance of the |
| | | drives, |
| | | laminar flow |
| 3 | Rising cubically | Turbulent flow of pumps and fans |

The following formula (I) therefore describes the mean power consumption P[W] as a function of the rate of production v [products and/or steps/time unit]:

P(v)=a₀+a₁·v+a₂·+a₃·v³ (1)

The energy consumption W_{prod} during processing is the integral of the power consumption over the period T_{prod} of the processing.

$${W}_{prod} ( v ) = {\int }_{0}^{{T}_{prod}} {a}_{0} + {a}_{1} \cdot v + {a}_{2} \cdot {v}^{2} + {a}_{3} \cdot {v}^{3} d t \qquad ( 2 )$$

It follows from T_{prod}=N/v that:

$${W}_{prod} ( v ) = {a}_{0} \cdot \frac{N}{v} + {a}_{1} \cdot N + {a}_{2} \cdot v \cdot N + {a}_{3} \cdot {v}^{2} \cdot N \qquad ( 3 )$$

When account is taken of energy consumption during outage (off, standby, idling etc.), the total energy consumption W_{ges} is yielded as follows:

$${W}_{ges} ( v ) = {a}_{0} \cdot \frac{N}{v} + {a}_{1} \cdot N + {a}_{2} \cdot v \cdot N + {a}_{3} \cdot {v}^{2} \cdot N + {a}_{still} \cdot ( {T}_{ges} - \frac{N}{v} ) \qquad ( 4 )$$

The minimum permissible speed is yielded as:

$${v}_{prod , min} = \frac{N}{{T}_{ges}} \qquad ( 5 )$$

The parameters N and T_{ges} are known.

A rate of production v₀ with the minimum energy consumption is determined by minimizing the cost function W_{ges} for v=v_{prod,min}.

However, apart from the energy consumption, other costs also come into consideration as costs to be reduced (for example to be minimized), for example financial costs. Aside from the pure energy consumption, the energy costs per kWh together with fixed operating costs (for example labor costs, maintenance charges etc.) also play a role here.

The coefficients used for a cost function within the scope of the disclosure can be determined in different advantageous ways. The determination is performed automatically in an appropriately set up arithmetic logic unit.

In accordance with a first embodiment, the coefficients are determined in accordance with at least one measurement run. In this case, the costs E are measured for a plurality of different processing speeds v, for example the energy consumption is measured by an appropriate measuring instrument. By way of example, four measuring points suffice in the case of a polynomial of 3^{rd} degree. The coefficients can then be determined from the measuring points (E/v). It is expedient to perform one measurement each for v=0 and three further processing speeds greater than zero. The three further speeds are expediently selected such that there exists at least one value smaller than v₀ and at least one value greater than v₀. This can be achieved by measuring the minimum permissible speed and the maximum permissible speed. Alternatively, this can be achieved by determining the gradient of the cost function between the measuring points, and measuring further measuring points until there has been a change in the sign of the gradient.

Alternatively, it is possible to measure very many processing speeds over the entire permissible speed range, this corresponding to running through the measuring range in an essentially continuous fashion. The result is obtained as a table of measuring points or a table of interpolation points from which the coefficients can be determined, for example, using the method of least error squares. In accordance with a further embodiment, the table of measuring points is used directly to determine the suitable processing speed by searching for the desired costs in the table of measuring points and extracting the associated processing speed from the table of measuring points. An interpolation is required, if appropriate.

In accordance with a further embodiment, the coefficients can be determined during normal operation (that is to say not in a special measurement run). Here, the costs are once again measured for different speeds. However, it is now a question of speeds that occur in normal operation (or lie close to such). The determination of the coefficients in accordance with this embodiment can, if appropriate, last longer than the determination of the coefficients by a special measurement run. Consequently, the suitable processing speed is set to a later time, but in return the measurement run can be saved, and this can lead overall to advantages in time and costs.

Once the coefficients have been determined, a minimum of the cost function is determined analytically or numerically. Alternatively, the cost function is represented graphically such that the operator can select the suitable processing speed therefrom. A touch screen is particularly suitable for this. Alternatively or in addition, the costs per product/processing are determined as a function of the processing speed and displayed to the operator. The instantaneous operating point is expediently indicated in this display. It is therefore possible for the potential savings to be rendered particularly clear, and the operator obtains the information as to which speed changes lead to cost savings.

In order to simplify the embodiment just described, it can be provided to set the coefficient a₃=0. In this refinement, three measuring points already suffice to determine the coefficients, which determination is expediently carried out for v=0 and two further processing speeds greater than zero. If more than three processing speeds are measured, the coefficients can be determined more accurately via the method of least error squares.

If the energy consumption is measured as costs, this is preferably performed using a single energy measuring instrument, preferably at the feeding point of the machine. Alternatively, a plurality of decentrally arranged measuring instruments are used and their measured values are summed. In the decentral configuration, it is also firstly possible to determine the coefficients decentrally and then sum them. The decentral determination of the coefficients can respectively be performed in accordance with one of the above-described alternatives, in particular. In the case of the decentral configuration, not all energy consumers need be fitted with a measuring instrument. For example, consumers are known (such as, for example, modern electric drives) that can automatically determine their energy consumption internally. Also known are consumers whose energy consumption can be taken from data sheets.

An inventive arithmetic logic unit, for example a control device of a processing machine is set up, in particular in programming terms, to carry out an inventive method.

The implementation of the disclosure in the form of software is also advantageous, since this enables particularly low costs, in particular when an executing arithmetic logic unit is also used for further tasks and is therefore present in any case. Suitable data carriers for providing the computer program are, in particular, floppy disks, hard disks, flash memory, EEPROMs, CD-ROMs, DVDs and more besides. It is also possible to download a program through computer networks (Internet, Intranet etc.).

Further advantages and configurations of the disclosure follow from the description and the attached drawing.

The above-mentioned features and those features still to be explained below can be applied not only in the respectively specified combination, but also in other combinations or on their own without departing from the scope of the present disclosure.

### BRIEF DESCRIPTION OF THE DRAWING

The subject matter of the disclosure is illustrated schematically in the drawing with the aid of an exemplary embodiment, and is described in detail below with reference to the drawing.

FIG. 1 shows a processing machine that is a printing machine and is operated within the scope of the disclosure.

FIG. 2 shows exemplary profiles of the energy consumption plotted against time for different processing speeds.

FIG. 3 shows the graph of an exemplary cost function.

### DETAILED DESCRIPTION

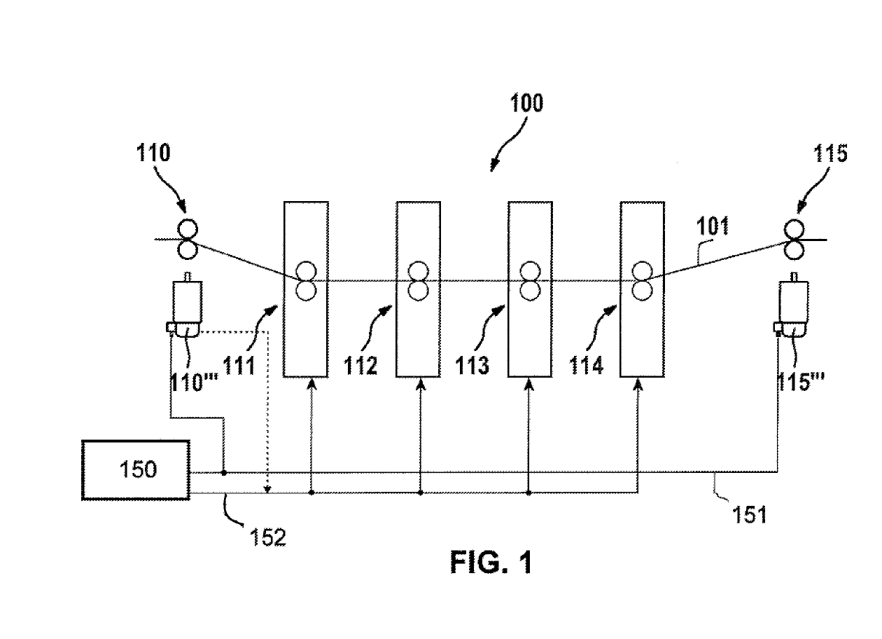

A processing machine exemplified as printing machine is illustrated schematically in FIG. 1 and denoted overall by 100. A printing material, for example, paper 101, is fed to the machine via an infeed 110. The paper 101 is guided through processing devices configured here as printing elements 111, 112, 113, 114, printed and output again through an outfeed 115. In the example shown, the infeed and the outfeed serve to transport the printing material at a mean transport speed. Alternatively or in addition, it is possible to provide appropriate driven processing devices that process the material and transport it.

The infeed 110 has a drive 110′″ and the outfeed 115 has a drive 115′″ that are respectively connected via a data link 151 to a (transport) control device 150, for example a PLC. The drive 110′″ and 115′″ in this case contain, for example, a motor and driving circuits. The data link 151 is configured as a real time enabled field bus connection, for example, as a SERCOS III connection. By way of example, a leading axis position is transmitted digitally (“without using a shaft”) to the infeed 110 and the outfeed 115 via the data link 151.

The printing elements 111 to 114 are, for example, digital printing elements based on an inkjet principle, or electrophotographically operating digital printing elements. However, it is equally possible to provide analog printing elements (flexo printing, offset printing etc.). The core of the disclosure is in no way related to the type of machine being operated.

By way of example, the printing elements transfer the printed image onto the material 101 line by line. As is known, transmitter signals are transmitted on an appropriate transmitter line 152 in order to drive the printing elements 111 to 114. As in the present example, the transmitter signals can be generated as transmitter emulation by the control device 150 or—as indicated by the dashed arrow—by a rotary transducer. A further configuration option is offered by a transmitter simulation connection from the driving circuits of the drives 110 and 115 via the transmitter line to the digital printing elements. As illustrated in FIG. 1, the transmitter information is generally transmitted in a bus structure or (not illustrated) in star fashion. In the latter case, a plurality of transmitter signal outputs are required in the system.

In practice, the energy consumption of all components illustrated is a function of the processing speed, the latter being defined as the number of the finished printed products (that is to say all colors) per time unit.

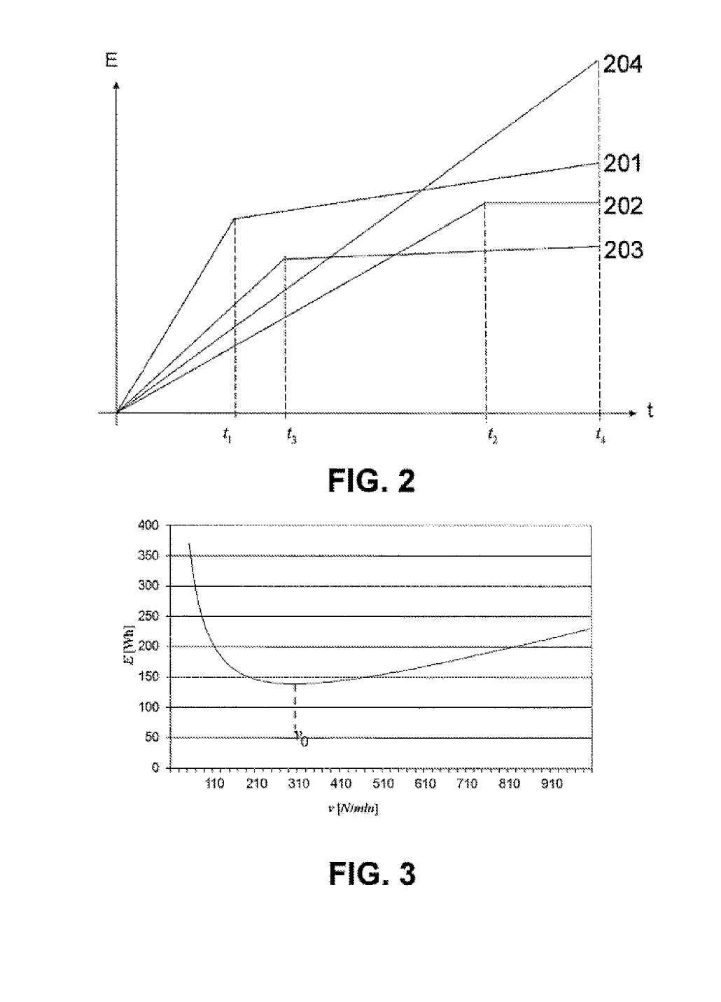

Exemplary profiles of the energy consumption are illustrated in FIG. 2 plotted against the time for different processing speeds.

The energy consumption E (for example in kWh) is plotted on the ordinate, and the elapsed time t (for example in minutes) is plotted on the abscissa.

The diagram shows the energy E fed to an exemplary processing machine over the time t, a defined number of processing steps being carried out or a defined number of products being produced. The time period available for this is T_{ges} and extends from 0 to t₄. The next processing cycle usually starts after this time.

Four exemplary cases 201-204 are distinguished, wherein it is assumed that the energy consumption per time unit (corresponds to the gradient in the diagram) is also different for different processing speeds. The processing speed itself is generated indirectly from the respective profile, more accurately from the position of a kink in the profile.

The profile 201 corresponds to the usual case, when the processing machine is operated at the maximum permissible processing speed. The desired steps/products are then taken/produced at the earliest time t₁, and the processing machine is subsequently left on at standstill. The energy consumption per time unit at standstill is correspondingly lower, and so the graph has a gentler gradient after the kink.

The profile 203 corresponds to a case in which the processing machine is operated at a somewhat reduced processing speed. The desired steps/products are then taken/produced at time t₃, and the processing machine is subsequently switched into an energy saving mode (for example standby). The energy consumption per time unit in the energy saving mode is very low, and so the graph has virtually no gradient after the kink.

The profile 202 corresponds to a case in which the processing machine is operated at a further reduced processing speed. The desired steps/products are then taken/produced at time t₂, and the processing machine is subsequently switched off. The energy consumption per time unit in the switched off state is essentially zero, and so the graph has no gradient after the kink.

Finally, the profile 204 corresponds to the case in which the processing machine is operated at the minimum permissible processing speed. The desired steps/products are then taken/produced exactly at time t₄, there being no subsequent standstill phase.

The profiles in accordance with FIG. 2 are purely exemplary. The profiles are generally specific as to product and also, if appropriate, as to the machine. Other influences such as, for example, the ambient temperature, can also influence the profiles.

It emerges that the total energy (that is to say E(t₄)) expended at the end of the cycle is minimal for the profile 203. The associated processing speed is determined within the scope of the present disclosure. Nowadays, the machine operator has no information relating to the product-specific energy-optimum processing speed. It follows that the machine operator cannot make use of the possible savings potential.

A diagram of an exemplary cost function E(v) dependent on the processing speed v is illustrated in FIG. 3. Here, the energy consumption E in [Wh] is plotted against the processing speed v in [N/min]. It may also be seen that a minimum in the energy consumption at approximately v₀=310 N/min is present. The following are used as coefficients:
a₀=500 [W]
a₁=50 [Ws]
a₂=20 [Ws²]
a₃=0 [Ws³]
N=2000 [products]

The suitable processing speed v₀ is determined in accordance with the methods already explained within the scope of the disclosure. The processing machine is then operated at the suitable processing speed v₀ so that the costs are minimal on condition that a desired number N of processing steps or products can be executed or produced at a predetermined time T_{ges}.

What is claimed is:

1. A method for low cost operation of a processing machine comprising:
determining a suitable processing speed, wherein the suitable processing speed is a processing speed which leads to predetermined costs in a predetermined processing time during operation of the processing machine;
operating the processing machine at the suitable processing speed; and
determining costs as a function of the processing speed.

2. The method of claim 1, wherein determining the suitable processing speed includes minimizing, locally or globally, a cost function dependent on the processing speed.

3. The method of claim 2, wherein the cost function is a polynomial function.

4. The method of claim 3, further comprising:
determining costs for a number of different processing speeds during a measurement run or during normal operation; and
determining coefficients of the polynomial function from measuring points.

5. The method of claim 4, further comprising:
storing, in product-specific fashion, at least one of the suitable processing speed, the cost function, and the coefficients.

6. The method of claim 2, further comprising:
representing the cost function dependent on the processing speed on a graph; and
selecting the suitable processing speed from the graph.

7. The method of claim 1, further comprising:
measuring the suitable processing speed by:
determining costs for a plurality of processing speeds, and
determining, as the suitable processing speed, a processing speed having costs closest to the predetermined costs.

8. The method of claim 1, wherein the processing machine is an industrial machine, for example, a printing machine, stamping machine, packaging machine, CNC machine or conveying machine.

9. An arithmetic logic unit for carrying out a method for low cost operation of a processing machine comprising:
a first mechanism configured to determine a suitable processing speed, wherein the suitable processing speed is a processing speed which leads to predetermined costs in a predetermined processing time during operation of the processing machine;
a second mechanism configured to operate the processing machine at the suitable processing speed; and
a third mechanism configured to determine costs as a function of the processing speed.
